(19) United States
(12) Patent Application Publication
(10) Pub. No.: US 2008/0243555 A1
(43) Pub. Date: Oct. 2, 2008

(54) Method and system for insurance of fines

(76) Inventors: Amos Azaria, Moshav Bet Gamliel (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/731,827

(22) Filed: Apr. 2, 2007

(51) Int. Cl. G06Q 40/00

(52) U.S. Cl. 705/4

(57) ABSTRACT

Insurance coverage to pay for fines including vehicle parking and other offences. Means of identification of insurer and insured to enable payment by insurance company direct to the fining authority.

### FIELD OF THE INVENTION

This invention is in the field of insurance and more particularly creating an insurance policy to cover the risk of being fined.

### BACKGROUND OF THE INVENTION

Insurance policies cover a wide range of subjects and with certain non-conventional insurance companies virtually anything can be insured and premiums are charged according to the risk involved. Lloyds insures of London is an example of such an insurance company.

Once a newly insured risk is accepted in the insurance world usually there are adopted norms of conditions and premiums offered by numerous insurance companies. The subject of this invention is one such example of a new risk in the insurance world.

As with all insurance the person or company offering the insurance will make calculations of the statistical likelihood of the insured risk occurring and thereby calculate the premium to be charged.

It may be argued that this type of insurance is against public policy as it may cause people to take lightly the crimes that are punishable by fine. Against this argument it should be noted that insurance is widely acceptable and even in some cases a legal requirement in other cases of offences that are in their essence far more serious than crimes that are merely punishable by fine. These latter kind of crimes are the lightest kind of crimes.

An example of this is car insurance that is usually partly voluntary and partly compulsory, where the insurance deals with such serious matters as injury and death of innocent passers by or travelers in another car involved in an accident with the insured car. In these type of cases it is not said that car insurance should be banned because it encourages more reckless driving than would otherwise be, even though there is some truth to the statement.

An example of a crime that is often punishable by fine is parking offences. If these were insured the insurance company could impose such restrictions as it felt fit to prevent abuse of the insurance and hence losses for the company. There could be a deductible sum from each claim or on a sliding scale for example for the first five fines in a calendar month no deductible and the next five fines a percentage deductible and so on. A further disincentive to excess accumulation of crimes is the fact that in many countries a point system is established whereby in addition to a fine for certain traffic crimes the driver accumulates points against him, depending on the severity of the offence. After a certain amount of points so accumulated the driver has to re-take a driving course, a driving test or in extreme cases, have his license suspended for a period of time. This would therefore be an additional incentive for a person not to abuse the law and commit an excessive amount of crimes punishable by fine.

A reason for a person wishing to take such insurance against fines could be to even out such unexpected expenses that are required to be paid within a fixed time. A person often prefers to have a fixed regular payment, in this case being the insurance premium, which he can include in his monthly budgeting. Even if the premium had an element of deductible it would be easier to plan for than the demand to pay the full fine, especially as forgetfulness or other reason for non-payment often results in doubling the fine and eventually a hearing in court, involving large additional costs. Alleviating this risk would prevent headache and worry from drivers. It would also prevent the embarrassment a driver experiences when he enters his car on which a notice of a fine has been placed. In addition to the financial penalty the person fined has the aggravation and time wasting activity of waiting in line in the post office or bank to pay the fine.

It is often the local authority that loses from the current method of handling fines for traffic and other minor offences. Many times the person fined does not pay. In some countries this is a more wide-spread phenomenon than others. It was reported in one country that 26% of fines for traffic offences were unpaid resulting in losses in the hundreds of millions of dollars per year. This did not include the costs and trouble of trying to collect the unpaid fines.

With this invention, the fining authorities will be able to collect their fines in full and on time from the insurance company, thereby saving these heavy losses and the costs and trouble of trying to collect these unpaid fines.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

An object of this invention is to enable fines payable for traffic and other crimes to be covered by insurance.

Another object of this invention is for the insurer to be able to offer insurance only for specified fines.

Another object of this invention is to enable the insurer to limit the number of fines in any one category of offences that are covered by the insurance.

Another object of this invention is to enable the insurer to charge a deductible for all or a portion of fines charged.

Another object of this invention is to enable the insurer to charge a sliding scale of deductible depending on the number of fines charged or depending on the accumulated amount of money charged by these fines or a combination of the two.

Another object of this invention is to enable fines to be paid by the offender or on his behalf and the reimbursed by the insurer on demand subject to the terms and conditions of the insurance agreement.

Another object of this invention is to enable the insurer to have a system of identification whereby insurers could produce or display such identification that would confirm the insurer's current ownership of a policy of insurance of this invention with the intention that fining authorities could apply direct to the insurer for collection of the fine.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a chart showing some of the communications and monetary transactions involved in this invention.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

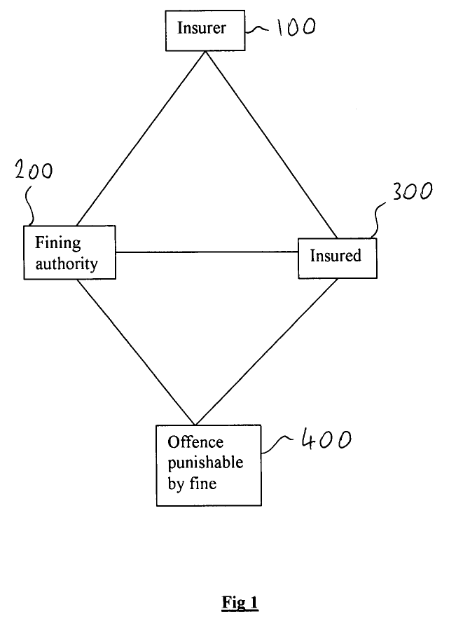

FIG. 1 shows a chart where the relationship between the insurer 100, the fining authority 200, the insured 300 and the offence 400 is depicted and the probable communications and monetary transactions carrying on between them is hereinafter described in more detail.

The first step could be for the insured 300 to turn to the insurer 100 and come to agreement regarding the extent of insurance coverage and other terms and conditions for fines incurred by the insured 300 and agreement concerning the payment of insurance premiums by the insured 300 to the insurer 100.

Upon the insured 300 incurring a fine 400 covered by the insurance agreement, the fining authority 200 can either collect the amount of the fine from the insured 300 or from the insurer 100. In case where the insured 300 pays the fine to the fining authority 200, the insurer can turn to the insurer 100 to apply for reimbursement.

What is claimed: The present invention is not intended to be limited to the embodiments described above, but to encompass any and all embodiments within the scope of the following claims.

1. A method and system of insurance comprising the insurance of fines charged for offences punishable by fine whereby an offender (the insured) enters into an agreement with an insurance provider (the insurer) where the insurer pays the fines of the insured subject to the said insurance agreement.

2. A method and system of insurance as claimed in claim 1 wherein the said insurance agreement between the insurer and the insured includes at least one of the following list of clauses; limiting the kind of offence whose fine is covered by the insurance, limiting the amount of fines covered by the insurance in a given period, limiting the total monetary value of fines covered by the insurance in a given period, charging the insured a deductible for each or a portion of the fines charged, charging a sliding scale premium for the insurance coverage depending on the number or kind of offences committed or depending on the total charge for fines in a given period, charging a sliding scale deductible depending on the number or kind of offences committed or depending on the total charge for fines in a given period.

3. A method and system of insurance as claimed in claim 1 wherein the identification of the insurer and the insured is made known to the fining authority whereby the fine charged is collected direct from the insurer.

4. A method and system of insurance as claimed in claim 1 wherein the insured is offered cheaper insurance premiums by fixed amounts for avoiding claiming on the said insurance agreement during a given period, known commonly as a “no claims bonus”.

5. A method and system of insurance as claimed in claim 1 wherein the insured is offered cheaper insurance premiums on a sliding scale basis for avoiding claiming on the said insurance agreement during a given period, known commonly as a “no claims bonus”.

6. A method and system of insurance comprising the insurance of fines charged for traffic offences punishable by fine whereby an offender (the insured) enters into an agreement with an insurance provider (the insurer) where the insurer pays the fines of the insured subject to the said insurance agreement.

7. A method and system of insurance as claimed in claim 6 wherein the said insurance agreement between the insurer and the insured includes at least one of the following list of clauses; limiting the kind of offence whose fine is covered by the insurance, limiting the amount of fines covered by the insurance in a given period, limiting the total monetary value of fines covered by the insurance in a given period, charging the insured a deductible for each or a portion of the fines charged, charging a sliding scale premium for the insurance coverage depending on the number or kind of offences committed or depending on the total charge for fines in a given period, charging a sliding scale deductible depending on the number or kind of offences committed or depending on the total charge for fines in a given period.

8. A method and system of insurance as claimed in claim 6 wherein the identification of the insurer and the insured is made known to the fining authority by identifying names or numbers whereby the fine charged could be collected direct from the insurer.

9. A method and system of insurance as claimed in claim 8 wherein the said identification is visible from the exterior of a vehicle.

10. A method and system of insurance as claimed in claim 6 wherein the insured is offered cheaper insurance premiums by fixed amounts for avoiding claiming on the said insurance agreement during a given period, known commonly as a “no claims bonus”.

11. A method and system of insurance as claimed in claim 6 wherein the insured is offered cheaper insurance premiums on a sliding scale basis for avoiding claiming on the said insurance agreement during a given period, known commonly as a “no claims bonus”.
